(19) United States
(12) Patent Application Publication
(10) Pub. No.: US 2012/0229849 A1
(43) Pub. Date: Sep. 13, 2012

(54) CLIENT APPARATUS AND CONTROL METHOD THEREOF

(75) Inventor: Satoshi Hirakawa, Tachikawa-shi (JP)

(73) Assignee: CANON KABUSHIKI KAISHA, Tokyo (JP)

(21) Appl. No.: 13/407,327

(22) Filed: Feb. 28, 2012

(30) Foreign Application Priority Data
Mar. 9, 2011 (JP) 2011-052121

(51) Int. Cl. G06F 3/12

(52) U.S. Cl. 358/1.15

(57) ABSTRACT

A client apparatus analyzes document data to be printed by an image output apparatus. In accordance with the analysis result, the client apparatus transmits a print start message to instruct the image output apparatus to start print processing and then transmits the document data to a print service server apparatus to cause the print service server apparatus to generate print data, or transmits the document data to the print service server apparatus and then transmits the print start message to the image output apparatus.

### BACKGROUND OF THE INVENTION

1. Field of the Invention

The present invention relates to a client apparatus in which a client apparatus, print service server apparatus, and image output apparatus are connected via a network.

2. Description of the Related Art

Recently, mobile information terminals such as a mobile phone and mobile PC have rapidly prevailed with technological advance. In response, a system has been proposed which prints document data on a mobile information terminal, as well as a system that allows the user to designate printing of document data on a print service server from a mobile information terminal.

Japanese Patent Laid-Open No. 2006-146734 discloses an invention in which the user confirms document data on a print service server from a mobile terminal apparatus and instructs an output apparatus to print. A transmission apparatus inputs a document from a document original, and assigns a document ID to the document. Then, the transmission apparatus generates a document thumbnail image and transmits to the mobile terminal apparatus, electronic mail containing the document ID and thumbnail image. The mobile terminal apparatus transmits an output instruction containing the document ID to the output apparatus in accordance with a user instruction. The output apparatus requests a document corresponding to the document ID of the transmission apparatus, acquires the document from the transmission apparatus, and prints it, thereby outputting the document original.

However, in the technique disclosed in Japanese Patent Laid-Open No. 2006-14734, the image output apparatus needs to have a function for printing document data. This system cannot be implemented by an image output apparatus which cannot directly print document data. When the print service server apparatus generates print data, it needs to transmit the print data after generating the print data No optimum printing performance may be obtained depending on the type and print settings of document data.

For example, for document data of a small-size page with a large data amount, the print service server takes time to generate 1-page data, generating a reception waiting time in the image output apparatus. In addition, the image output apparatus needs to make a data request inquiry (polling) till the completion of transmission preparations, increasing the network load,

### SUMMARY OF THE INVENTION

The present invention provides an apparatus and method which minimize the waiting time of a printing apparatus and the network load in print processing.

According to one aspect of the present invention, there is provided a client, apparatus in a printing system in which the client apparatus, a print service server apparatus, and an image output apparatus are connected via a network, comprising: an analysis unit that analyzes document data to be printed by the image output apparatus; and a transmission unit that, in accordance with a result of the analysis by the analysis unit, transmits a print start message to instruct, the image output apparatus to start print processing and then transmits the document data to the print service server apparatus to cause the print service server apparatus to generate print data, or transmits the document data to the print service server apparatus and then transmits the print start message to the image output apparatus.

According to another aspect of the present invention, there is provided a method of controlling a client apparatus in a printing system in which the client apparatus, a print service server apparatus, and an image output apparatus are connected via a network, comprising: analyzing document data to be printed by the image output apparatus; and in accordance with a result of the analysis in the analyzing step, transmitting a print start message to instruct, the image output apparatus to start print processing and then transmitting the document data to the print service server apparatus to cause the print service server apparatus to generate print data, or transmitting the document data to the print service server apparatus and then transmitting the print start message to the image output apparatus.

Further features of the present invention will become apparent from the following description of exemplary embodiments (with reference to the attached drawings).

### BRIEF DESCRIPTION OF THE DRAWINGS

FIG. 1A is a block diagram showing the schematic arrangement of a printing system;

FIG. 1B is a block diagram showing the arrangements of a client, apparatus and image output apparatus;

FIG. 1C is a block diagram showing the arrangement of a print, service server apparatus;

FIG. 2 is a flowchart showing print processing by the image output apparatus;

FIG. 3 is a flowchart showing document data transmission processing;

FIG. 4 is a flowchart showing print data generation & transmission processing;

FIG. 5 is a timing chart corresponding to the processing order of flow 1 in FIG. 3;

FIG. 6 is a timing chart corresponding to the processing order of flow 2 in FIG. 3; and

FIG. 7 is a view showing the arrangement of a user interface screen.

### DESCRIPTION OF THE EMBODIMENTS

Preferred embodiments of the present invention will now be described in detail with reference to the accompanying drawings. An embodiment will exemplify a printing system in a cloud environment where a print service server apparatus exists on the Internet.

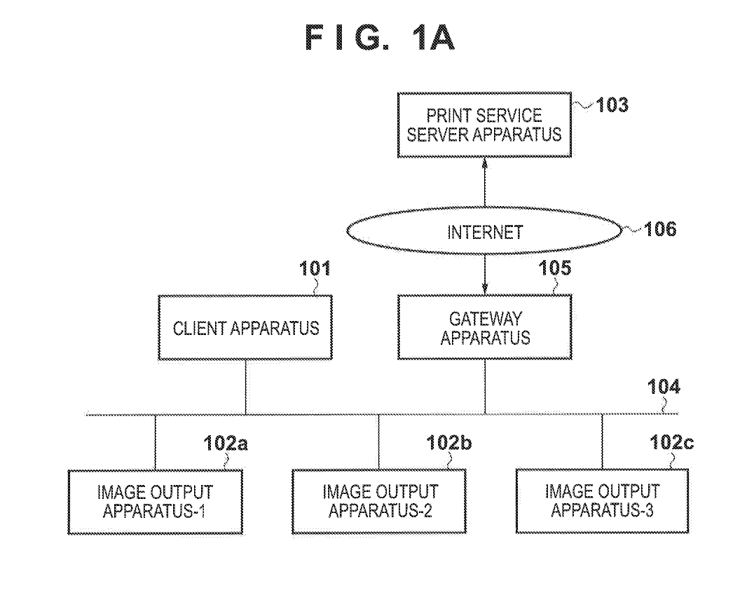

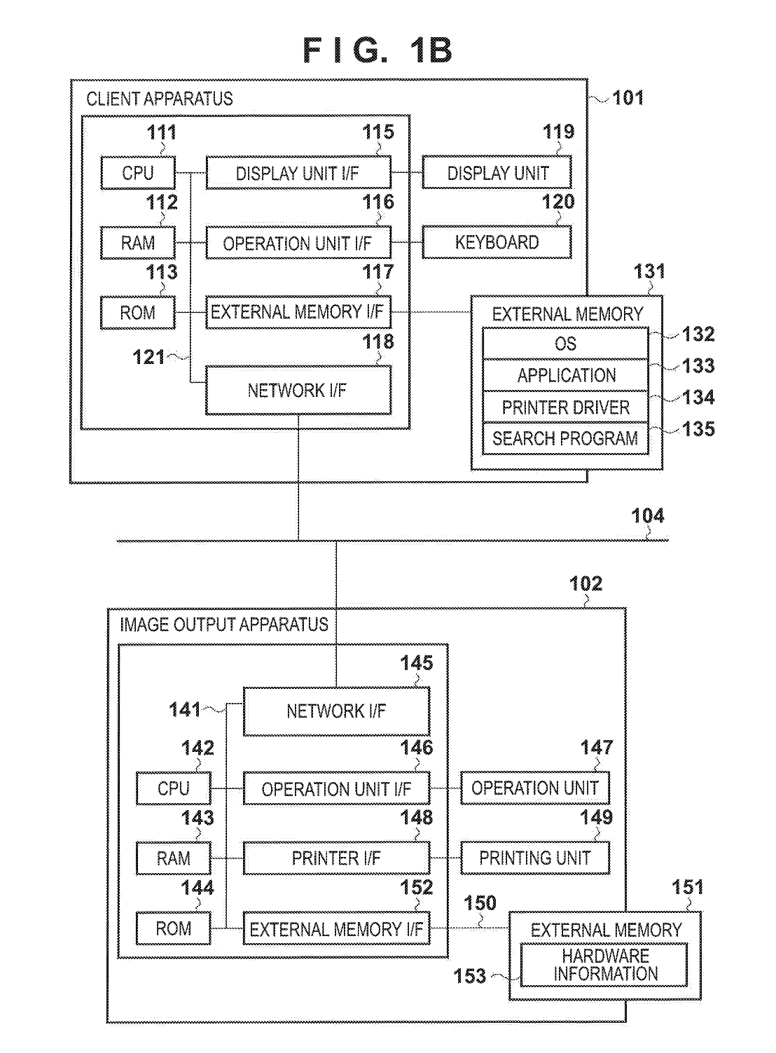

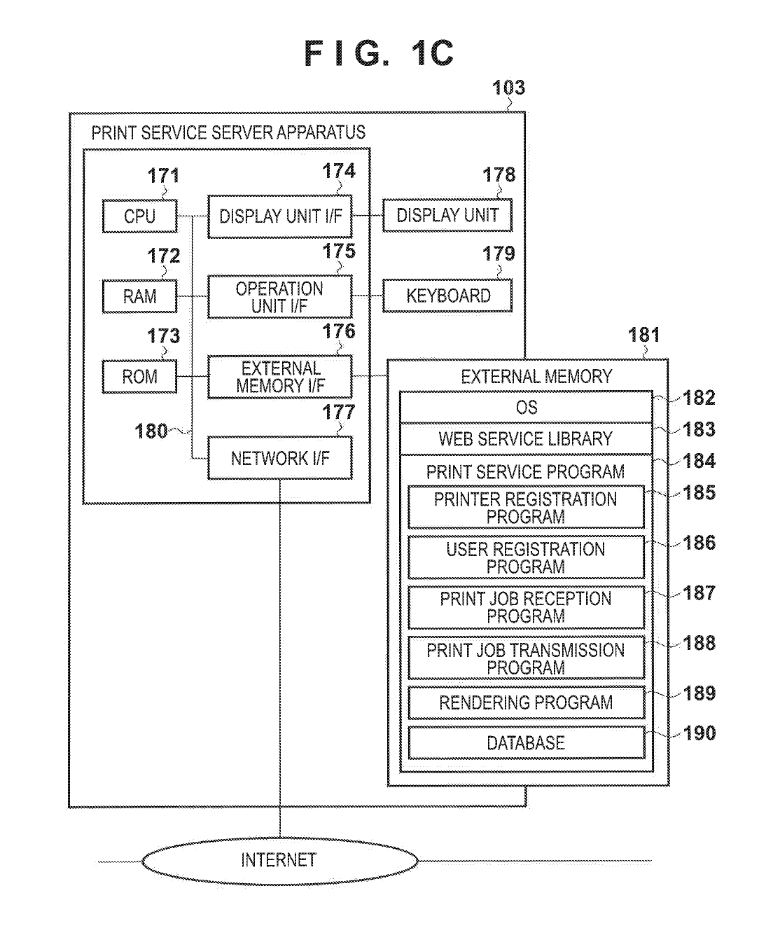

FIG. 1A is a block diagram showing the schematic arrangement of a printing system according to the present invention. The printing system in the embodiment includes a client apparatus 101 which is operated by the user to designate printing, and a plurality of image output apparatuses 102 serving as output destinations in printing. The client apparatus 101 is, for example, a personal computer (PC) or mobile terminal. The image output apparatus 102 may be a multi-function peripheral (MFP) having a plurality of functions such as the facsimile apparatus and scanner. The client apparatus 101 and image output apparatuses 102 are connected to each other via a network 104 such as a LAN. The network 104 may be wired or wireless. The client apparatus 101 and a print service server apparatus 103 are connected via a gateway apparatus 105 present on the network 104 and the Internet 106.

FIG. 1B is a block diagram showing the arrangements of the client apparatus 101 and image output apparatus 102 in FIG. 1A. In the client apparatus 101, a CPU 111 executively controls devices connected to a system bus 121 in accordance with programs stored in a RAM 112. The RAM 112 functions even as a main memory, work area, and the like for the CPU 111. A ROM 113 stores various programs and data.

An operation unit I/F 116 controls key inputs from a keyboard 120 and a pointing device (for example, a touch panel or mouse: not shown). A display unit I/F 115 controls display on a display unit 119. An external memory I/F 117 controls access to an external memory 131 such as a flash memory or solid state disk (SSD). The external memory 131 functions as a storage medium capable of storage or reading by the client apparatus. The external memory 131 stores an operating system program (to be referred to as an OS) 132, various applications 133, and a printer driver 1344. Note that the printer driver 134 includes a local printing driver and print service driver.

A network I/F 118 is a network control unit and allows connection to a local network. The client apparatus 101 may include a second network I/F (not shown), control communication to a mobile network and the like to connect to a wireless base station via a network, and be connectable to the print service server apparatus 103. A search program 135 is a program for searching for a printer. Note that the search program 135 may be stored in the RAM 112 or ROM 113 in addition to the external memory 131.

The arrangement of the image output apparatus 102 will be explained. A CPU 142 of the image output apparatus 102 controls the operation of the overall image output apparatus 102. The CPU 142 executively controls devices connected to a system bus 141 in accordance with programs stored in a RAM 143. The RAM 148 functions as a main memory, work area, and the like for the CPU 142, and is used as an input information rasterization area and environmental data storage area. The RAM 143 has even an NVRAM (Non-Volatile RAM) area, and can expand its memory capacity by an optional RAM connected to an expansion port (not shown). A ROM 144 stores various fonts, control programs and the like to be executed by the CPU 142, and various data.

A network I/F 145 transmits/receives data to/from the client apparatus 101, and transmits/receives data to/from the print service server apparatus 103. The network I/F 145 is implemented to suit the execution environment of a web service protocol or the like. A printer I/F 148 controls an interface with a printing unit 149 serving as a printer engine. An external memory I/F 152 controls access to an external memory 151. The external memory 151 includes a flash memory and solid state disk (SSD), and can store hardware information 153. When the external memory 151 such as a hard disk is not connected, the ROM 144 stores information and the like to be used in the client apparatus 101.

An operation unit I/F 146 controls an interface with an operation unit 147 for making various settings of the image output apparatus 102.

Next, the arrangement of the print service server apparatus 103 will be explained with reference to FIG. 1C. In the print service server apparatus 103, a CPU 171 executively controls devices connected to a system bus 180 in accordance with programs stored in a RAM 172. The RAM 172 functions even as a main memory, work area, and the like for the CPU 171. A ROM 173 is a memory which stores various programs and data.

An operation unit I/F 175 controls key inputs from a keyboard 179 and a pointing device (for example, a touch panel or mouse: not shown). A display unit I/F 174 controls display on a display unit 178. An external memory I/F 176 controls access to an external memory 181 such as a hard disk (HD) or solid state disk (SSD). The external memory 181 stores an operating system program (to be referred to as an OS) 182, a web service library 183, and various print service programs 184. Further, the external memory 181 functions as a storage medium capable of storage or reading by a computer, and stores a user file, edit file, and the like (not shown).

The print service programs 184 include a printer registration program 185, user registration program 186, print job reception program 187, and print job transmission program 188. Further, the print service programs 184 include a rendering program 189 and database 190. A network I/F 177 performs communication control processing with the client apparatus 101 and image output apparatus 102 via the Internet 106.

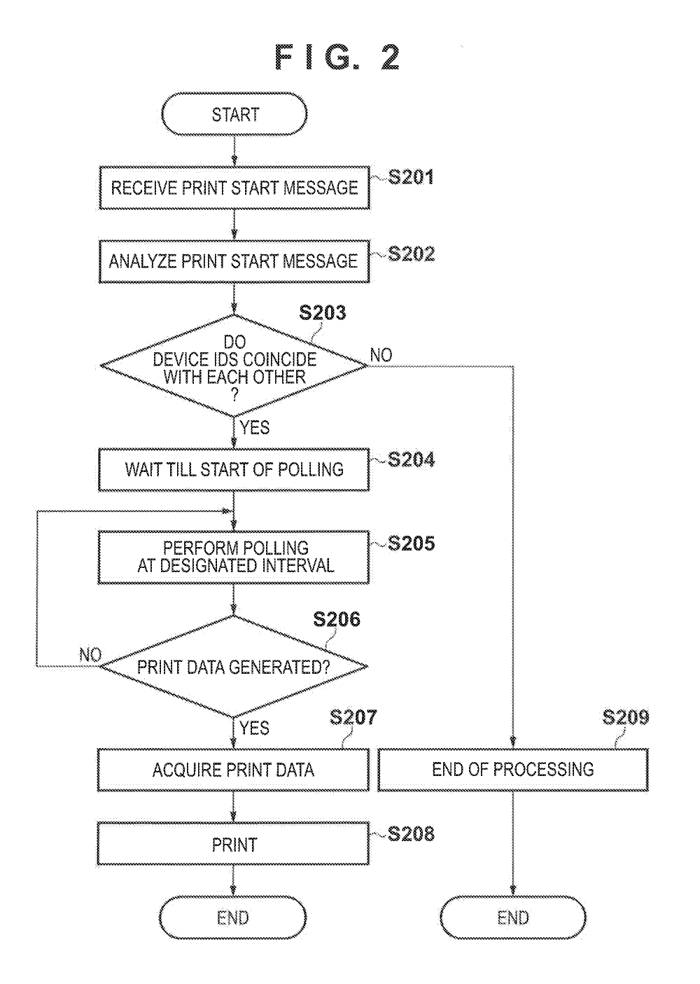

Print processing executed by the image output apparatus 102 upon receiving a print start message from the client apparatus 101 will be described with reference to a flowchart shown in FIG. 2 in step S201, the CPU 142 of the image output apparatus 102 receives a print start message from the client apparatus 101. In addition to a print start instruction command, the print start message contains a document ID for specifying a document to be printed, and a device ID for specifying an image output apparatus to print. The document ID is an ID which is assigned uniquely to each document data by the print service server apparatus 103 in step S402 (to be described later). The device ID is an ID which is registered in advance by the printer registration program 185 of the print service server apparatus 103, and is assigned uniquely to each of the image output apparatuses communicable with the print service server apparatus 103. The print start message contains even information of the poling start timing and polling interval when the image output apparatus 102 requests the print service server apparatus 103 to acquire print data.

In step S202, the CPU 142 analyzes the print start message received in step S201. In step S203, the CPU 142 determines whether the device ID contained in the print start message analyzed in step S202 coincides with the device ID of the image output apparatus 102. If the CPU 142 determines in step S203 that the contained device ID does not coincide with the device ID of the image output apparatus 102, the process advances to step S209 and ends. If the CPU 142 determines in step S203 that the contained device ID coincides with the device ID of the image output apparatus 102, the process advances to step S204, and the CPU 142 waits till the start of polling. Information of the polling start time (when polling will start) is obtained by referring to the polling information contained in the print start message analyzed in step S202.

In steps S205 and S206, the CPU 142 polls the print service server apparatus 103 for a print data acquisition request. Information of the polling interval (how many seconds of the interval to perform polling) is obtained by referring to the polling information contained in the print message analyzed in step S202.

After print data is generated, the CPU 142 acquires the print data from the print service server apparatus 103 in step S207. In step S208, the CPU 142 prints the print, data acquired in step S207.

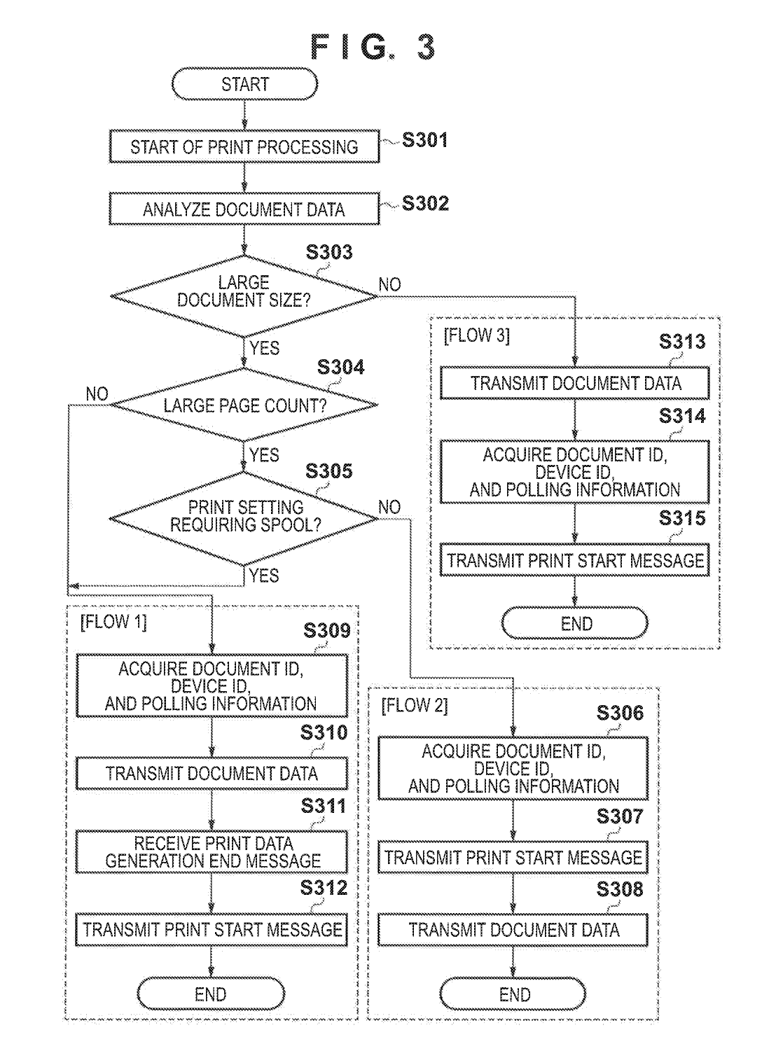

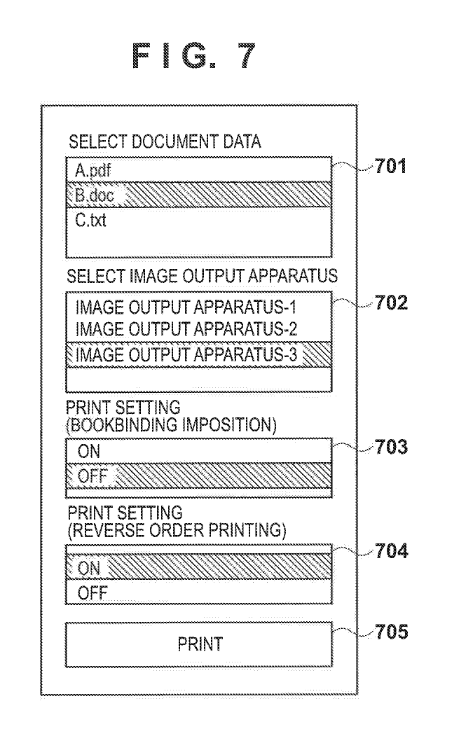

Processing of transmitting document data held in the client apparatus 101 will be described with reference to a flowchart shown in FIG. 3. In step S301, the CPU 111 of the client apparatus 101 starts print processing. More specifically, the client apparatus 101 starts print processing upon detecting pressing of a print button 705 on a print setting user interface screen shown in FIG. 7. The print setting user interface screen is displayed on the display unit 119 of the client apparatus 101, and contains various setting screens used when performing print processing. In an example shown in FIG. 7, the print setting user interface screen contains a document data selection screen 701, image output apparatus selection screen 702, print setting screen (bookbinding imposition) 702, and print setting (reverse order printing) 704. Print processing starts at settings selected on the print setting user interface screen.

In step S302, the CPU 111 analyzes document data. More specifically, the CPU 111 acquires the size and page count of the document data to be printed by using a script and OS provided function, and analyzes the document data. In step S303, the CPU 111 determines whether the document data size acquired in step S302 is large or small. Whether the document data size is large or small is determined by determining whether it is equal to or larger than a preset threshold. The document data size is affected by the transmission time of document data from the client apparatus 101 to the print service server apparatus 103. Thus, the threshold may be changed depending on the transfer rate of a communication path which connects the client apparatus 101 and print service server apparatus 103.

If the CPU 111 determines that the document data size is large, the process advances to step S304, and the CPU 111 determines whether the document data page count acquired in step S302 is large or small. Whether the document data page count is large or small is determined by determining whether it is equal to or larger than a preset threshold. If the CPU 111 determines that the document data page count is large, the process advances to step S305, and the CPU 111 determines whether print settings include a print setting requiring spool of one job. The print setting requiring spool of one lob is for example, a print setting of performing bookbinding imposition or reverse order printing on paper by the print service server apparatus 103. In bookbinding imposition, the first and final logical pages need to be imposed on the same physical page. In reverse order printing, printing needs to be executed from the final page. Hence, these print settings require spool of one job.

If the CPU 111 determines that a print setting requiring spool of one job does not exist, it executes processes in the order of flow 2 shown in FIG. 3. In step S306, the CPU 111 acquires a document ID, device ID, and polling information from the print service server apparatus 103. The document ID is an ID which is assigned uniquely to each document data by the print service server apparatus 103 in step S402 (to be described later). The client apparatus 101 transmits the name and hash value of document data to be printed to the print service server apparatus 103, and acquires an ID assigned to the document data.

The device ID is an ID registered in advance by the printer registration program 185 of the print service server apparatus 103. The device ID is assigned uniquely to each image output apparatus communicable with the print service server apparatus 103.

In this example, the client apparatus 101 acquires, from the print service server apparatus 103, the device ID of an image output apparatus selected on the image output apparatus selection screen 702 of the user interface screen shown in FIG. 7. The polling information is formed from information of the polling start timing and polling interval. The client apparatus 101 acquires polling information which is calculated by the print service server apparatus 103 in step S404 (to be described later).

In step S307, the CPU 111 transmits a print start message to the image output apparatus 102. The print start message contains a print, start designation command, and the document ID, device ID, and polling information which have been acquired in step S306. At this time, by using a transmission method which does not specify a transmission destination, such as multicast, the print start message can be transmitted to the image output apparatus 102 even if the reception side address is unknown. In step S308, the CPU 111 transmits the document data to the print service server apparatus 103.

If the CPU 111 determines in step S304 that the document data page count is small or in step S305 that a print setting requiring spool of one job exists, it executes processes in the order of flow 1 shown in FIG. 3. In step S309, the CPU 111 acquires a document ID, device ID, and polling information from the print service server apparatus 103. The document ID, device ID, and polling information to be acquired are the same as those to be acquired in step S306.

In step S310, the CPU 111 transmits the document data to the print service server apparatus 103. In step S311, the CPU 111 receives a print data generation end message from the print service server apparatus 103. In step S312, the CPU 111 transmits a print start message to the image output apparatus 102. The print start message contains a print start designation command, and the document ID, device ID, and polling information which have been acquired in step S309.

Flow 1 and flow 2 are different in the processing order of document data transmission and print start message transmission. In flow 1, after transmitting document data in step S310, the print start message is transmitted in step S312. To the contrary, in flow 2, after transmitting the print start message in step S307, document data is transmitted in step S308.

In this example, processes are executed in the order of flow 1 when the document data size is large and the page count is small, or when the document data size is large, the page count is large, and spool is necessary. In contrast, processes are executed in the order of flow 2 when the document data size is large, the page count is large, and spool is unnecessary.

If the CPU 111 determines in step S303 that the document data size is small, it executes processes in the order of flow 3 shown in FIG. 3. In step S313, the CPU 111 transmits document data to the print service server apparatus 103. In step S314, the CPU 111 acquires a document ID, device ID, and polling information from the print, service server apparatus 103. The document ID, device ID, and polling information to be acquired are the same as those to be acquired in step S306.

In step S315, the CPU 111 transmits a print start message to the in output apparatus 102. The print start message contains a print start designation command, and the document ID, device ID, and polling information which have been acquired in step S314. Flow 3 is processing executed when the document data size is small. The printing performance hardly changes regardless of which of document data transmission and print start message transmission is processed first. Thus, processes may be performed in either order. In this example, document data transmission is executed first.

In this manner, the order to execute document data transmission and print start message transmission is changed depending on the type and print settings of document data, obtaining optimum performance.

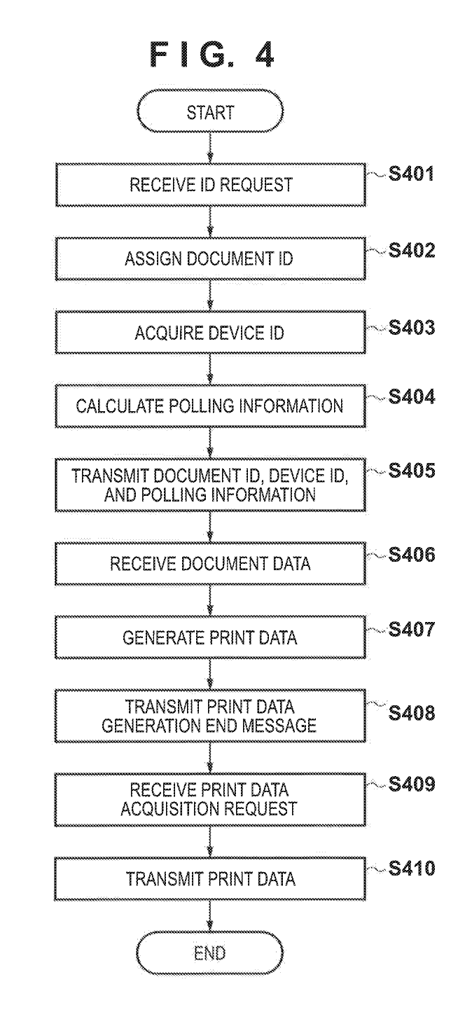

Processing of generating and transmitting print data in the print service server apparatus 103 will he explained with reference to a flowchart shown in FIG. 4. In step S401, the CPU 171 of the print service server apparatus 103 receives an ID request from the client apparatus 101. The requested IDs are a document ID for specifying document data to be printed, a device ID for specifying an image output apparatus 102 to print, and polling information.

In step S402, the CPU 171 assigns a document ID. The print service server apparatus 103 manages the document ID as an ID unique to each document data. Also, the print service server apparatus 103 associates the document ID with a document name and hash value transmitted from the client apparatus 101.

In step S403, the CPU 171 determines a device ID. In this case, the CPU 171 searches a plurality of device IDs registered in advance in the print service server apparatus 103 for a device ID corresponding to the image output apparatus 102 which is to print. The image output apparatus 102 to print is selected by the user on the image output apparatus selection screen 702 of the user interface screen shown in FIG. 7. The CPU 171 determines the device ID based on the name of the selected image output apparatus 102.

In step S404, the CPU 171 calculates polling information. The polling information is formed from information of the polling start timing and polling interval. The polling start timing is set to the timing when print data can be transmitted to the image output apparatus 102, such as the timing considering the end time of another print processing in progress in the print service server apparatus 103. The polling interval is set to be narrower than the interval of normal polling in the image output apparatus 102. In this example, polling information is calculated before the print service server apparatus 103 receives document data. However, it is also effective to calculate polling information depending on the type of document data after receiving document data. For example, when the document data page count is large, the polling start timing can be set to the prospective end timing of generating print data of the first page. In this way, the timing and interval of polling can be adjusted.

In step S405, the CPU 171 transmits, to the client apparatus 101, the document ID, device ID, and information which have been determined in steps S402, S403, and S404. In step S406, the CPU 171 receives document data from the client apparatus 101. The document data is made to correspond to the above-mentioned document ID.

In step S407, the CPU 171 generates print data. The generated print data has a data format capable of print processing by the image output apparatus 102 which has been registered with the device ID determined in step S403.

In step S408, the CPU 171 transmits a print data generation end message to the client apparatus 101. In step S409, the CPU 171 receives a print data acquisition request from the image output apparatus 102. Upon receiving the print data acquisition request, the process advances to step S410, and the CPU 171 transmits the print data generated in step S407.

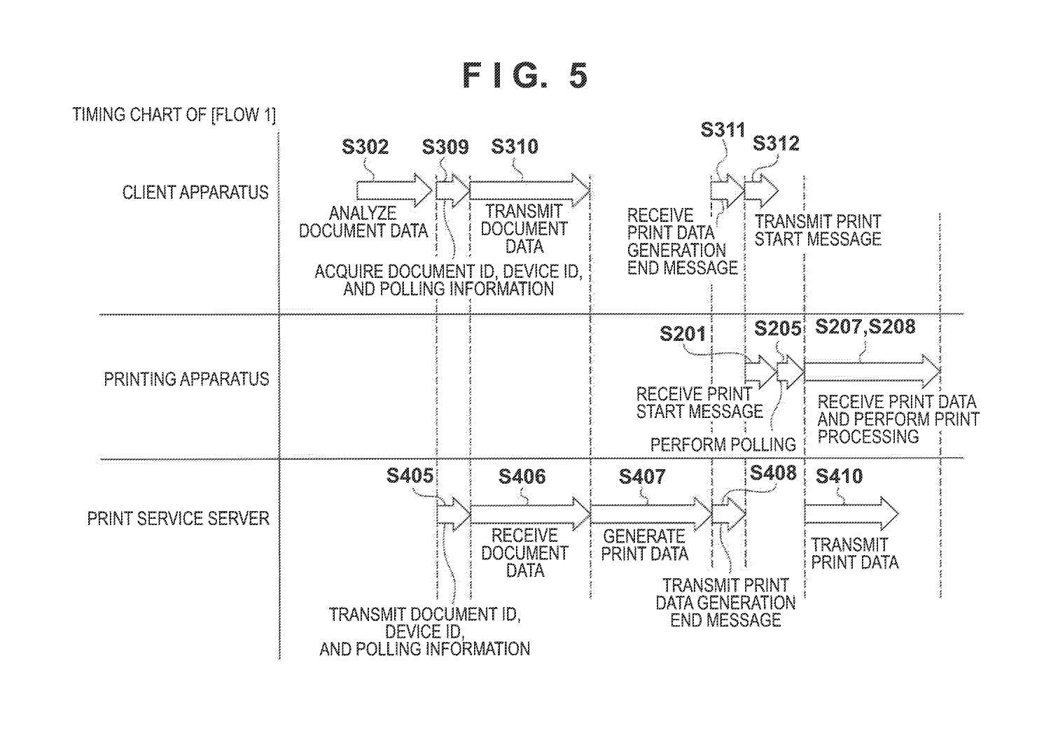

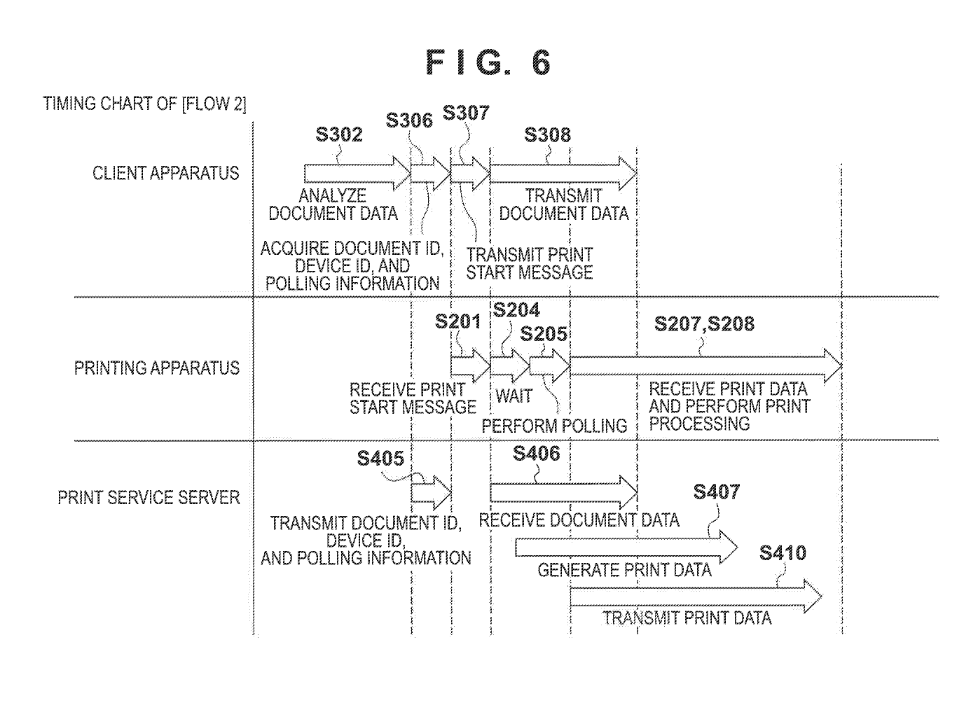

FIGS. 5 and 6 are timing charts showing print processes to be executed by the client apparatus 101, image output apparatus 102, and print service server apparatus 103. The difference between FIGS. 5 and 6 is the processing order of document data transmission and print start message transmission. FIG. 5 corresponds to the processing order of flow 1 in FIG. 3. FIG. 6 corresponds to the processing order of flow 2 in FIG. 3. Flow 3 in FIG. 3 is not a feature of the present invention and is not shown in the timing chart.

In the example of FIG. 5, processing proceeds in order of transmitting document data and then transmitting a print start message. In the example of FIG. 6, processing proceeds in order of transmitting a print start message and then transmitting document data.

The timing chart shown in FIG. 5 will be explained. First, the client apparatus 101 analyzes document data. More specifically, the size and page count of document data to be printed are acquired using a script and OS provided function. Then, the client apparatus 101 acquires a document ID, device ID, and polling information from the print service server apparatus 103. As processing corresponding to this processing, the print service server apparatus 103 transmits the document ID, device ID, and polling information in response to the acquisition request from the client apparatus 101.

The client apparatus 101 transmits the document data to the print service server apparatus 103. As processing corresponding to this processing, the print service server apparatus 103 receives the document data from the client apparatus 101. At this time, the document data corresponds to the document ID.

The print service server apparatus 103 generates print data. The print data to be generated has a data format capable of print processing by the image output apparatus 102. After the end of generating print data, the print service server apparatus 103 transmits a print data generation end message to the client apparatus 101.

The client apparatus 101 receives the print data generation end message from the print service server apparatus 103. The client apparatus 101 transmits a print start message to the image output apparatus 102. The print start message contains a print start designation command, document ID, device ID, and polling information. As processing corresponding to this processing, the image output apparatus 102 receives the print start message from the client apparatus 101.

The image output apparatus 102 polls the print service server apparatus 103 for a print data acquisition request. Information of the polling interval (how many seconds of the interval to perform polling) is obtained by referring to the aforementioned polling information.

The print service server apparatus 103 transmits the print data. As processing corresponding to this processing, the image output apparatus 102 acquires print data from the print service server apparatus 103. At the same time, the image output apparatus 102 prints the acquired print data. As a result, the print processing shown in FIG. 5 ends.

Next, the timing chart shown in FIG. 6 will be explained. First, the client apparatus 101 analyzes document data. More specifically, the size and page count of document data to be printed are acquired using a script and OS provided function. Then, the client apparatus 101 acquires a document ID, device ID, and polling information from the print service server apparatus 103. As processing corresponding to this processing, the print service server apparatus 103 transmits the document ID, device ID, and polling information in response to the acquisition request from the client apparatus 101.

The client apparatus 101 transmits a print start message to the image output apparatus 102. The print start message contains a print start designation command, document ID, device ID, and polling information. As processing corresponding to this processing, the image output apparatus 102 receives the print start message from the client apparatus 101.

The image output apparatus 102 waits till the start of polling. The polling start time is obtained by referring to the polling information contained in the print, start message.

The client apparatus 101 transmits the document data to the print service server apparatus 103. As processing corresponding to this processing, the print service server apparatus 103 receives the document data from the client apparatus 101. The document data corresponds to the above-mentioned document ID.

Parallel to the document elate transmission/reception processing, the print service server apparatus 103 generates print data. The generated print data has a data format capable of print processing by the image output apparatus 102.

Parallel to the print data generation processing, the print service server apparatus 103 transmits the print data to the image output apparatus 102. As processing corresponding to this processing, the image output apparatus 102 acquires the print data from the print service server apparatus 103. At the same time, the image output apparatus 102 prints the acquired print data. After that, the print processing shown in FIG. 6 ends.

According to the embodiment, the order of document data transmission and print start message transmission is changed depending on the document size, the page count, and the print processing requiring spool. This can minimize the waiting time of the printing apparatus and the network load.

Especially in a printing system formed from a client apparatus typified by a mobile terminal, a print service server apparatus, and an image output apparatus, optimum performance can be obtained in accordance with the type and print settings of document data.

### Other Embodiments

Aspects of the present invention can also be realized by a computer of a system or apparatus or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-052121, filed Mar. 9, 2011, which is hereby incorporated by reference herein in its entirety.

What is claimed is:

1. A client apparatus in a printing system in which the client apparatus, a print service server apparatus, and an image output apparatus are connected via a network, comprising:
an analysis unit that analyzes document data to be printed by the image output apparatus; and
a transmission unit that in accordance with a result of the analysis by said analysis unit, transmits a print start message to instruct the image output apparatus to start print processing and then transmits the document data to the print service server apparatus to cause the print service server apparatus to generate print data, or transmits the document data to the print service server apparatus and then transmits the print start message to the image output apparatus.

2. The apparatus according to claim 1, wherein
said analysis unit analyzes at least a size and page count of the document data, and whether a print setting requiring spool exists, and
when the size of the document data is larger than a predetermined threshold, the page count is larger than a predetermined threshold, and the print setting requiring spool exists, said transmission unit transmits the print start message to the image output apparatus and then transmits the document data to the print service server apparatus.

3. The apparatus according to claim 1, wherein
said analysis unit analyzes at least a size and page count of the document data, and whether a print setting requiring spool exists, and
when the size of the document data is larger than a predetermined threshold, the page count is smaller than a predetermined threshold, and the print setting requiring spool does not exist, said transmission unit transmits the document data to the print service server apparatus and then transmits the print start message to the image output apparatus.

4. The apparatus according to claim 1, wherein the print start message contains at least a document ID for specifying the document data, a device ID of the image output apparatus, and a polling start timing and a polling interval when the image output apparatus requests the print service server apparatus to acquire the print data.

5. The apparatus according to claim 4, wherein the polling start timing and the polling interval can be adjusted in accordance with a result of the analysis by said analysis unit.

6. The apparatus according to claim 1, wherein said analysis unit determines a size of the document data based on a predetermined threshold, and changes the threshold in accordance with a transmission speed of a communication path between the client apparatus and the print service server apparatus.

7. A method of controlling a client apparatus in a printing system in which the client apparatus, a print service server apparatus, and an image output apparatus are connected via a network, comprising:
analyzing document data to be printed by the image output apparatus; and
in accordance with a result of the analysis in the analyzing step, transmitting a print start message to instruct the image output apparatus to start print processing and then transmitting the document data to the print service server apparatus to cause the print service server apparatus to generate print data, or transmitting the document data to the print service server apparatus and then transmitting the print start message to the image output apparatus.

8. A non-transitory computer-readable recording medium recording a program for causing a computer to execute a client apparatus control method defined in claim 7.
